(19) United States
(12) Patent Application Publication
(10) Pub. No.: US 2017/0169715 A1
(43) Pub. Date: Jun. 15, 2017

(54) USER STATE MODEL ADAPTATION THROUGH MACHINE DRIVEN LABELING

(71) Applicants: NESE ALYUZ CIVITCI, Istanbul (TR); EDA OKUR, Istanbul (TR); ASLI ARSLAN ESME, Istanbul (TR); SINEM ASLAN, Istanbul (TR); ECE OKTAY, Istanbul (TR); SINEM E. METE, Istanbul (TR); HASAN UNLU, Istanbul (TR); DAVID STANHILL, Hoshaya (IL); VLADIMIR SHLAIN, Haifa (IL); PINI ABRAMOVITCH, Haifa (IL); EYAL ROND, Sunnyvale, CA (US)

(72) Inventors: NESE ALYUZ CIVITCI, Istanbul (TR); EDA OKUR, Istanbul (TR); ASLI ARSLAN ESME, Istanbul (TR); SINEM ASLAN, Istanbul (TR); ECE OKTAY, Istanbul (TR); SINEM E. METE, Istanbul (TR); HASAN UNLU, Istanbul (TR); DAVID STANHILL, Hoshaya (IL); VLADIMIR SHLAIN, Haifa (IL); PINI ABRAMOVITCH, Haifa (IL); EYAL ROND, Sunnyvale, CA (US)

(21) Appl. No.: 14/964,458

(22) Filed: Dec. 9, 2015

(51) Int. Cl. G09B 5/06; G06N 99/00

(52) U.S. Cl. CPC G09B 5/06; G06N 99/005

(57) ABSTRACT

Embodiments herein relate to generating a personalized model using a machine learning process, identifying a learning engagement state of a learner based at least in part on the personalized model, and tailoring computerized provision of an educational program to the learner based on the learning engagement state. An apparatus to provide a computer-aided educational program may include one or more processors operating modules that may receive indications of interactions of a learner and indications of physical responses of the learner, generate a personalized model using a machine learning process based at least in part on the interactions of the learner and the indications of physical responses of the learner during a calibration time period, and identify a current learning state of the learner based at least in part on the personalized model during a usage time period. Other embodiments may be described and/or claimed.

### FIELD

Embodiments of the present disclosure generally relate to the field of computer-based learning and in particular to identifying the engagement state of a learner during the learning process.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

With the rapid growth of computer-based training and computer-based education, adaptive learning technologies that enable identification of a learner's engagement state through real-time analysis of the learner's interaction with an educational device has improved a learner's ability to learn by altering the presented content based on the questions that the learner has correctly or incorrectly answered. Machine learning (ML) techniques may be used to develop artificial intelligence (AI) models that determine the learner's engagement state and output the state such that it can be used to tailor presentation of the educational material. In addition to having characteristics that can be generalized to the human population, individual humans exhibit many unique behaviors. Although generic ways of expressing basic emotions such as happy, sad, and others can be defined, each person's way of expressing themselves demonstrates a diversification over this generic definition. Personalized rather than generic AI models may be generated to account for these differences. In some cases, it may not be possible or desirable to use self-labeling by the learner in generating a personalized model, such as when the learner may have a disability such as an autism spectrum condition (ASC) that may render it difficult for them to self-label his or her emotions.

### BRIEF DESCRIPTION OF THE DRAWINGS

Embodiments of the personalized model generation techniques of the present disclosure may overcome this limitation. The techniques will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a diagram of a computer-based learning environment incorporated with the personalized model generation techniques of the present disclosure, according to various embodiments.

FIG. 2 is a diagram illustrating phases and training sets involved in generation of a personalized model, according to various embodiments.

FIG. 3 is a diagram of a personalization scheme showing a method of generating a personalized model, according to various embodiments.

FIG. 4 is a flow diagram illustrating a method for operating a learning engagement state recognition engine, including generating a personalized model, according to various embodiments.

FIG. 5 is a diagram illustrating an example user interface for a program used by human labelers to label learning engagement states, according to various embodiments.

FIG. 6 illustrates a component view of an example computer system suitable for practicing the disclosure, according to various embodiments.

FIG. 7 illustrates an example storage medium with instructions configured to enable a computing device to practice the present disclosure, according to various embodiments.

### DETAILED DESCRIPTION

Apparatuses, methods and storage media associated with generating a personalized model for identifying a learning engagement state of a learner are described herein. In embodiments, an apparatus may include a computing platform with one or more processors running modules that receive indications of interactions of a learner with an educational program as well as indications of physical responses of the learner collected substantially simultaneously as the learner interacts with the educational program, and from that generate a personalized model using a machine learning process during a calibration time period, and identify a current learning engagement state of the learner based at least in part on the personalized model and the received indications of physical responses of the learner during a usage time period. In various embodiments, the personalized model may be generated with a semi-supervised machine learning process that uses a performance and/or a context classifier of a generic model to retrain an appearance classifier of the generic model to generate a personalized model having a personalized appearance classifier. In some embodiments, the personalized model may be used in an adaptive learning system that may include facial motion capture, eye tracking, speech recognition, and/or gesture or posture recognition, such as that described in U.S. patent application Ser. No. 14/820,297, titled “System and Method for Identifying Learner Engagement States”, filed Aug. 6, 2015. In an embodiment, the adaptive learning system may include a facial expression analysis engine operating on the same or a different computer system as the adaptive learning system that may provide indications of learner facial-motion, indications of learner eye tracking, or indications of learner posture. In an embodiment, the adaptive learning system may include a learner proximity/gesture analysis engine operating on the same or a different computer system as the adaptive learning system that may provide indications of learner gestures, indications of learner proximity to an educational device hosting an educational program, indications of learner sounds, or indications of learner words spoken.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternative embodiments of the present disclosure and their equivalents may be devised without parting from the spirit or scope of the present disclosure. It should be noted that like elements disclosed below are indicated by like reference numbers in the drawings.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or elements are in direct contact.

The term “real-time” may mean reacting to an event at the same rate, or sometimes at the same rate as they unfold.

The term “substantially simultaneously” may mean at the same time or nearly at the same time.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

As used herein, the term “engine” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

In various embodiments, one or more artificial intelligence (AI) based methods of determining a level of learning engagement of a learner who is interacting with an educational program may be used. In embodiments, a machine learning model may implement the AI concept of an adaptive learning model associated with a particular learner. That way, in a semi-supervised approach, evaluations of the learner, over time, may result in highly accurate associations of a learner engagement state, which may include behavioral and/or emotional attributes, to observable characteristics of the learner using sensing data, environmental data, learner data, and data from an instruction module driving the educational device. In various embodiments, these associations may be captured in a personalized machine learning model for the particular learner by using machine learning techniques to update an appearance classifier of a generic model. In various embodiments, the behavioral attributes may include, but are not limited to, on-task or off-task. Emotional attributes may include, but are not limited to, highly motivated, calm, bored, or confused/frustrated.

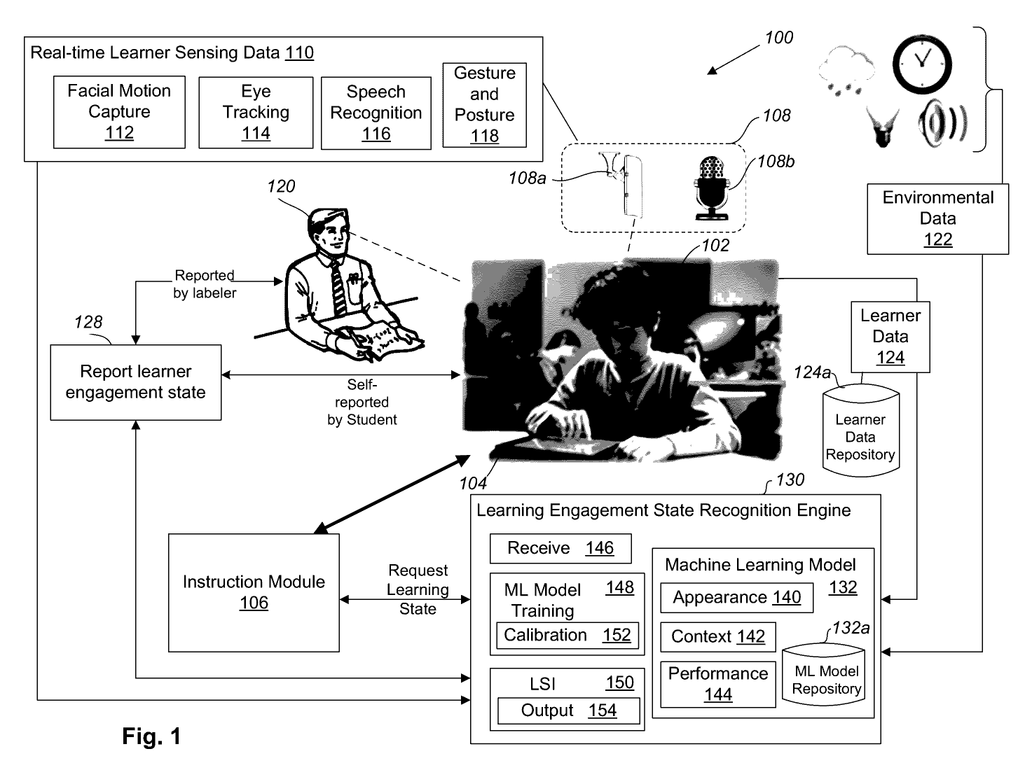

Referring now to FIG. 1, a diagram of a computer-based learning environment 100, incorporated with personalized model generation using machine learning techniques according to various embodiments, may be shown. The computer-based learning environment 100 may include a learner 102 interacting with an educational device 104 that may be driven by an instruction module 106. In embodiments, the learning environment 100 may be used for computer-based training to learn a specific task, for example how to play a game, or for user-paced education to learn broader concepts, such as history or philosophy.

As the learner 102 may interact with the educational device 104, the instruction module 106 may receive a current learning engagement state of the learner 102, and tailor the instructions based at least in part on the received current learning engagement state. In embodiments, the current learning engagement state may indicate a level of attention or inattention that the learner 102 has with regard to the educational device 104. In non-limiting examples, this may include learner 102 behavior such as on-task or off-task, or may include an emotional state of the learner 102 such as highly motivated, calm, bored, or confused/frustrated. In some embodiments, the current learning engagement state may include a combination of both one or more behaviors and one or more emotional states of the learner 102.

To determine and provide the current, or real-time engagement level of the learner 102, learner sensing equipment 108, such as a two-dimensional (2D) or three-dimensional (3D) video camera 108a, a microphone 108b or any other wide variety of equipment such as physiological sensors, accelerometers, or other soft sensors may be used to capture real-time learner sensing data 110 that a learning engagement state recognition engine 130 may use to determine the current learning engagement state of the learner 102. For example, the real-time learner sensing data 110 may include information regarding facial motion capture 112 that may capture facial expressions, head movement, and the like. In some embodiments, near real-time rather than real-time data may be captured and used. Information regarding eye tracking 114 may capture the areas at which the learner 102 looks on the educational device 104, or what the learner 102 is looking at if not looking at the device at all. Information regarding speech recognition 116 may capture phrases, questions, sounds of happiness or frustration of the learner 102. Information regarding gesture and posture 118 may capture a calm, focused state; a sleeping state; or an agitated and distracted state of the learner 102. In embodiments, some or all of the learner sensing equipment 108 may be included as a part of the educational device 104 and/or the host apparatus of instruction module 106.

In addition to real-time learner sensing data, other relevant information may also be used by the learning engagement state recognition engine 130. For example, environmental data 122 may also be used. This data may include, but is not limited to, interior lighting, interior ambient noise, the current time, the month and day, and the outside weather, for example outside temperature, cloudiness, humidity, and the like.

In addition, learner data 124 may be used for the learner engagement state recognition engine 130. This data may include academic, medical, and/or psychological information about a learner 102, in addition to an identification of a learner. In embodiments, learner data 124 may include performance data captured by the learning environment. In embodiments, learner data 124 may be stored in a learner data repository 124a, which may include information for one or more learners.

Finally, the instruction module 106, that is driving the educational device 104, may provide information to the learning engagement state recognition engine 130. This information may include, but is not limited to, the correctness of answers to questions presented on educational device 104, learner interaction characteristics with the educational device 104, such as the time it takes the learner 102 to answer a question, the time it takes the learner 102 to read a given text, the number of times the learner 102 requests a correction to a selected answer, the speed at which questions are presented to the learner 102, and/or the position/location of the question on the educational device 104.

The learning engagement state recognition engine 130 may take this information and may store it in a machine learning (ML) model 132, which may include a ML model data repository 132a for the ML model 132. Generally, the ML model 132 may be tuned by a learning algorithm, and may be able to approximate the capability of nonlinear functions of outputs based on given inputs. In this disclosure, the ML model 132 may be able to, among other things, learn to associate a variety of inputs and to associate them with a particular current learning state of a learner 102. In various embodiments, learning algorithms that employ a random forest or a boosted support vector machine (SVM) may be used. In other embodiments, AI techniques other than a random forest or a boosted SVM may be used for the ML model 132.

In embodiments, the data that may be received from real-time learner sensing data 110, learner data 124, environmental data 122, and/or instruction module 106 data may be identified in terms of: (1) appearance features, (2) contextual features, and (3) performance features of a learner 102. In embodiments these may be referred to as categorical sets. Data summarized from these three categorical sets may then be provided to the learning engagement state recognition engine 130 to either determine the learner's 102 current learning engagement state, and/or to update the ML model 132 associated with the learning engagement state recognition engine 130. In embodiments, a principle of categorizing features in this way may be that various observable task performance features and hidden states may relate to student engagement. In other words, a student's engagement state at a given time may be influenced by the context and the student state early on, which in turn may influence the student's appearance and performance now. In embodiments using this taxonomy of appearance, context and performance features: appearance features may correspond to real-time learner sensing data 110, performance features may correspond to performance data from the instruction module 106, and context features may refer to environmental data 122, learner data 124, and context data from the instruction module 106. Data presented in this way and associated with an identified learner engagement state may be used to train, calibrate, or update the ML model 132 by the learning state recognition engine 130.

In embodiments, the real-time learner sensing data 110, associated with learner 102 appearance feature identification, may include not only raw data captured from the sensing devices 108, but may also process this data, for example by the real-time learner sensing data 110 module, and provide different levels of information to the learning engagement state recognition engine 130. This information may include information captured per video frame, per video segment, and/or per a temporal window. For example: at the first level, the features of the learner 102 that are identified may include: a rectangle of the face detected, one of seventy-eight facial landmarks, head pose information (e.g. yaw, pitch, and roll), face tracking confidence level, and/or facial expression intensity values. At a second level, the features of the learner 102 that are identified may include three-dimensional head motion (velocity, acceleration, total energy, etc.), head pose and angular motion, and/or facial expression feature values. At a third level, features of the learner 102 may include per-segment features such as total motion, total energy, duration, peak value, and still interval duration. At a fourth level, the previous data may be used to determine certain behavioral patterns such as posture (sitting up straight, leaning forward, leaning back, sunk in chair), motion patterns (forward-backward nodding, left-right shaking), head-gaze direction (looking up (thinking), looking down, looking away (distracted)), facial displays (eye closure, furled eyebrows, a blink, and/or yawn), and/or head-hand pose displays (leaning on hand, or scratching head).

In embodiments, environmental data 122, learner data 124, and context data from the instruction module 106 may be used to identify contextual features. A nonexclusive list of contextual features in these embodiments may include: learner age, learner gender, session type (assessment session or instructional video) time of day, exercise number in the current assessment session, current trial number (number of attempts) within the current question, lighting level, noise level, mouse location (in an x-y-coordinate system), the exercise number in the session, the session number, the duration of the current instructional video, the window number within the current instruction video or assessment session, average time spent on the question with all of its attempts, average number of hints used for this question with all its attempts, average number of trials until success for this question, video speed, whether subtitles are used, and/or the current trial number (number of attempts) so far from the beginning of the session.

In embodiments, instruction module 106 performance data may be used to identify performance features. A nonexclusive list of performance features may include: the time spent on an attempt, a grade (e.g. one equals success and zero equals fail), the time spent on question ranking relative to other learners, the total number of hints used for this question ranking relative to other learners, the number of trials until success ranking relative to other learners, which trial did the learner 102 succeed in, the number of hints used at the current attempt, the total time spent on a question with all of its attempts, the total number of hints used on the question with all of its attempts, the total number of hints requested so far from the beginning of the session, the number of current attempts failed after a hint was used (e.g., zero equals no, one equals yes), the percent of all past attempts that were correct in the current assessment session, the number of the last five problems that used hints, the total number of two wrong attempts in a row across all the problems in the current assessment session, the number of the last five attempts that were wrong, the number of the last eight attempts that were wrong, the total number of wrong first attempts from the beginning of the session, the total time spent on first attempts across all problems in the current assessment session, and/or the total time spent across all problems divided by the percent of all past attempts that were correct in the current assessment session.

In various embodiments, the ML model 132 may include an appearance classifier 140, a context classifier 142, and a performance classifier 144. The appearance classifier 140 may use the real-time learner sensing data 110 associated with learner 102 appearance feature identification to generate learning state identification data based on appearance features. The context classifier 142 may use the environmental data 122, the learner data 124, and contextual data from the instruction module 106 to generate learning state identification data based on contextual features. The performance classifier 144 may use performance data from the instruction module 106 to generate learning state identification data based on performance features.

In some embodiments, the learning engagement state recognition engine may include a receive module 146, a machine learning (ML) model training module 148, and a learning state identification (LSI) module 150. The ML model training module 148 may include a calibration module 152 and the LSI module 150 may include an output module 154 in various embodiments. The receive module 146 may be operated on one or more processors to receive indications of interactions of the learner 102 with an educational program and to receive indications of physical responses of the learner 102 collected substantially simultaneously as the learner 102 interacts with the educational program. In various embodiments, the calibration module 152 may be operated by the one or more processors to generate a personalized model using a machine learning process based at least in part on the interactions of the learner and the indications of physical responses of the learner during a calibration time period. The personalized model may be stored as an updated machine learning model 132. In various embodiments, the machine learning process may include a random forest technique, a boosted SVM, or some other ML process or technique.

In some embodiments, a generic machine learning model may have been previously generated and stored as the ML model 132. The calibration module 152 may generate the personalized model by retraining the appearance classifier 140 of the generic ML model 132 by determining a learning state label based at least in part on the performance classifier 144 of the generic ML model stored as the ML model 132 and retraining the appearance classifier 140 based at least in part on the learning state label. The appearance classifier 140 may be updated such that the ML model 132 is now a personalized ML model. In various embodiments, the receive module 146 may also receive indications of learning context and the calibration module 152 may be to determine the learning state label also based at least in part on the indications of learning context and the context classifier 142. In some embodiments, merged context/performance classifier that uses both the context classifier 142 and the performance classifier 144 may be used to retrain the appearance classifier 140.

In embodiments, labeling may be divided into behavior labeling and emotional labeling. Labeling by a classifier or a human may include a behavior and/or an emotional label. Behavior labeling may be related to the physical interaction between the learner 102 and the educational device 104. Behavioral labels may include, but are not limited to, on-task, off-task, unknown, and/or not available. Emotional labeling may be related to the current emotional state of the learner 102. Emotional labels may include, but are not limited to, highly motivated (the learner 102 was concentrating very hard, is enjoying the work, and is highly interested), calm (the learner is following the task on the educational device 104, but is not very focused or excited about it), bored (yawning, sleepy, doing something else, or not interested at all), confused/frustrated (asking questions to a teacher, angry, disgusted, or annoyed), unknown (cannot be decided), and/or not available (if the lesson content that may be displayed on the educational device 104 is not open).

In some embodiments, the LSI module 150 may be operated by the one or more processors to identify a current learning state of the learner based at least in part on the personalized model stored as the ML model 132 and the indications of physical responses of the learner during a usage time period. In some embodiments, the LSI module 150 may identify the current learning state based on a personalized model that includes a merged classifier including the appearance classifier 140, the context classifier 142, and the performance classifier 144. The current learning state of the learner may be used to tailor computerized provision of the education program during the usage period. In various embodiments, the current learning state of the learner may include a behavioral state and/or an emotional state. In some embodiments, the receive module 146 may receive a request for a current learning state of the learner during the usage time period. The output module 154 may determine a current learning state from the personalized model stored as the ML model 132 and the indications of physical responses during the usage time period, and output the determined current learning state. In various embodiments, the output module 154 may determine a confidence level for the determined current learning state using the personalized model and output the confidence level.

In some embodiments, in addition to retraining the appearance classifier 140 using the performance classifier 144 and/or the context classifier 142, the appearance classifier 140, the context classifier 142, and/or the performance classifier 144 may also be retrained based in part on labels of the learner 102 engagement state provided by a labeler 120 and/or the learner 102. In these embodiments, in addition to using sensing equipment 108, a report learner engagement state module 128 may ask for a real time learning state of learner 102 from a labeler 120 based on current observations, or from the learner 102 based on the learner's current experience.

In embodiments, the labeler 120, who may be in the form of a human observer, may observe the learner 102, label the observed learning engagement state of the learner in real-time, and report the learning state. In embodiments, the labeler 120 may report learning engagement states for a particular learner 102, or may be observing a plurality of learners and report on any particular one of the plurality. The request may come from the instruction module 106, or from another source. In addition, in embodiments, the labeler 120 may be directly viewing the learner 102, or may be viewing the learner from a remote location using video camera 108a or microphone 108b that may be at the location of the learner 102. In embodiments, the labeler 120 may be looking at a pre-recorded session of the learner 102 and labeling learner engagement states in order to update/calibrate a machine learning (ML) model 132 associated with the learner 102.

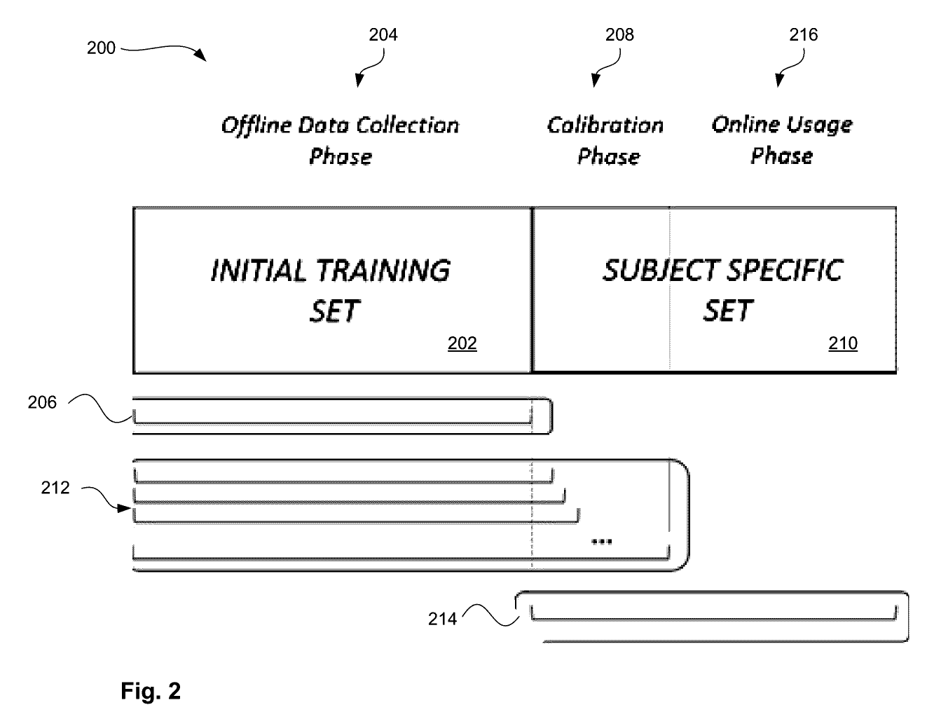

FIG. 2 is diagram illustrating phases and training sets involved in generation of a personalized model in accordance with various embodiments. In some embodiments, an initial training set 202 may be collected during an offline data collection phase 204 and used to generate a generic model 206. The generic model 206 may include appearance, context, and performance classifiers. The generic model 206 may be constructed using a set of users, whose data may be collected during an initial data collection phase. The generic model 206 may be trained to classify the state of a user, which can be generalized to unseen subjects. In constructing the generic model, a generalized state recognition engine may discard any subjective information that may be beneficial in understanding a particular user's state.

In a calibration phase 208, a subject, such as the learner 102, may be asked assessment questions enabling the learning engagement state recognition engine 130 to collect context and performance related features. The calibration phase 208 may also be referred to as a calibration time period in various embodiments. Labels may be assigned by the context classifier 142 and/or the performance classifier 144 that are used to retrain the appearance classifier 140 during the calibration phase 208. The assigned labels may be used to generate an augmented training set shown as a subject specific set 210 that is used to retrain the appearance classifier 140. In embodiments, the ML model training module 148 may be used to retrain the appearance classifier 140 with one or more ML techniques such as a random forest, a SVM, or a boosted SVM in an adaptation process to generate an adapted model. The label collection and adaptation process may be repeated a predefined number of times in various embodiments to generate a plurality of adapted models 212. The iterations updating the adapted model may be carried on until the end of the calibration phase. At the end of the calibration phase, the data acquired specific to the subject together with the assigned labels estimated by the context classifier 142 and/or the performance classifier 144 may be used to generate a final personalized model 214 that includes a personalized appearance classifier based on the subject specific set 210 without the initial training set 202. In an online usage phase 216, the personalized model 214 specific to the subject may be employed. In embodiments, the online usage phase 216 may also be referred to as a usage time period.

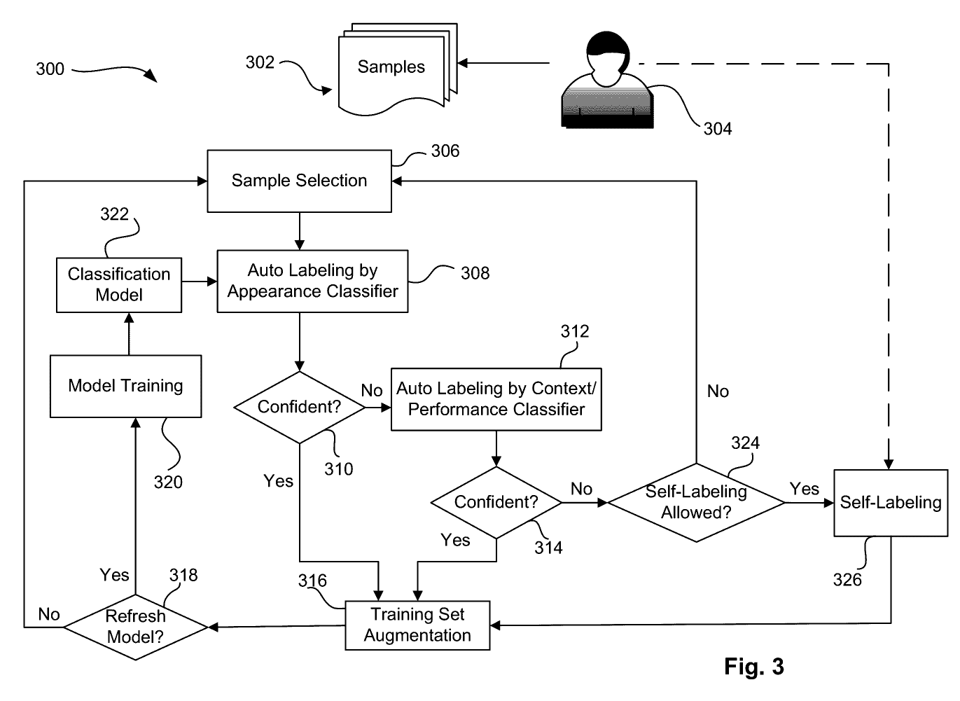

FIG. 3 is a diagram of a personalization scheme showing a method 300 of generating a personalized model during a calibration phase in accordance with some embodiments. During a calibration time period such as the calibration phase 208, a plurality of data samples 302 may be collected continuously for a user 304 such as the learner 102. The data samples 302 may include real-time learner sensing data 110, environmental data 122, learner data 124, context data from the instruction module 106, and/or performance data from the instruction module 106 in various embodiments. A sample selection stage 306 may select samples from the data samples 302. The selected samples may be selected based on samples that include a frequently occurring feature or a feature determined to be highly informative, such as a data metric being above a predefined threshold value in some embodiments. In an auto-labeling by appearance classifier stage 308, an appearance classifier such as the appearance classifier 140 may generate a label that may be an engagement state label based on appearance features in the selected data samples. The appearance classifier 140 used to generate the label may be a generic appearance classifier at the beginning of the process and may be retrained to be an adapted appearance classifier as the method 300 proceeds to generate adapted models. At an appearance classifier confidence block 310, it may be determined whether a confidence level of the auto-labeling performed by the appearance classifier in the auto-labeling by appearance classifier stage 308 is above a predetermined threshold value. In embodiments, the confidence level may be a real number ranging from zero to one, with zero meaning no confidence and one meaning the highest confidence (absolute certainty) that the learner 102 actual engagement state is the same as the assigned label. In other embodiments, a different scaling may be used, such as zero to one hundred for example. In some embodiments, the threshold value may be 0.85. In other embodiments, another threshold value may be used.

If the confidence level of the auto-labeling performed by the appearance classifier is not above the predetermined threshold value, the method 300 may proceed to an auto-labeling by context-performance classifier stage 312 where a context classifier such as the context classifier 142 and/or a performance classifier such as the performance classifier 144 may generate an engagement state label based on context and/or performance features in the selected data samples. At a context-performance classifier confidence block 314, it may be determined whether a confidence level of the auto-labeling performed by the context classifier and/or performance classifier in the auto-labeling by context-performance classifier stage 312 is above a predetermined threshold value. In embodiments, the confidence level may be a real number ranging from zero to one, with zero meaning no confidence and one meaning the highest confidence (absolute certainty) that the learner 102 actual engagement state is the same as the assigned label. In other embodiments, a different scaling may be used, such as zero to one hundred for example. In some embodiments, the threshold value may be 0.85. In other embodiments, another threshold value may be used.

If the confidence level of the auto-labeling performed by the context-performance classifier stage 312 is above the predefined threshold value at the context-performance classifier confidence block 314 or the confidence level of the auto-labeling performed by the appearance classifier is above the predetermined threshold value at the appearance classifier confidence block 310, the method 300 may proceed to a training set augmentation stage 316. The training set augmentation stage 316 may augment a training set of the appearance classifier using the currently selected sample and the label generated by the auto-labeling by context-performance classifier stage 312 if the label was generated at the auto-labeling by context-performance classifier stage 312 or the label generated by the appearance classifier if the label was generated at the auto-labeling by appearance classifier stage 310. In various embodiments, at the end of the calibration phase, the training set augmentation stage 316 may alter the training set such that it includes only data specific to the learner along with corresponding labels generated in the method 300 and does not include data from other student learners used in generating a generic model.

At a decision block 318, it may be determined whether the model should be refreshed in a retraining process. In some embodiments, it may be determined that the model should be retrained if a predetermined number of new samples have been added to the training set at the training set augmentation stage 316. In some embodiments, the model may be retrained after ten new samples have been added. In other embodiments, a different number of new samples may be required before retraining is performed. If it is determined that the model should not yet be refreshed, the method 300 may return to the sample selection stage 306 where an additional sample may be selected. If, at the decision block 318, it is determined that the model should be refreshed, the method 300 may proceed to a model training stage 320 where the model may be retrained. In various embodiments, the appearance classifier of the model may be retrained based on labels generated by the auto-labeling by context-performance classifier stage 312 that were added to the training set in multiple iterations at the training set augmentation stage 316. The retrained model may be stored at a classification model block 322 in various embodiments. The method 300 may then continue back to the auto-labeling by appearance classifier stage 308 in some embodiments.

If, at the context-performance classifier confidence block 314, it is determined that the confidence level of the auto-labeling performed at the context-performance classifier stage 312 is less than or equal to the predetermined threshold value, the method 300 may proceed to a decision block 324 where it may be determined whether self-labeling is allowed. If, at the decision block 324, it is determined that self-labeling is not allowed, the method 300 may return to the sample selection stage 306. If, at the decision block 324, it is determined that self-labeling is allowed, the method 300 may proceed to a self-labeling stage 326 where an engagement state label may be assigned to the selected sample by a human that may be a teacher, a parent, a caregiver, a trained labeling expert, or the learner in various embodiments. In some embodiments, self-labeling will not be allowed and only machine learning techniques may be used to retrain the appearance classifier. In other embodiments, self-labeling by a human that is not the learner may be allowed to augment the machine learning auto-labeling techniques. In embodiments where a human is allowed to augment the machine learning auto-labeling techniques, the context classifier and/or the performance classifier may also be updated in addition to the appearance classifier when the personalized model is generated.

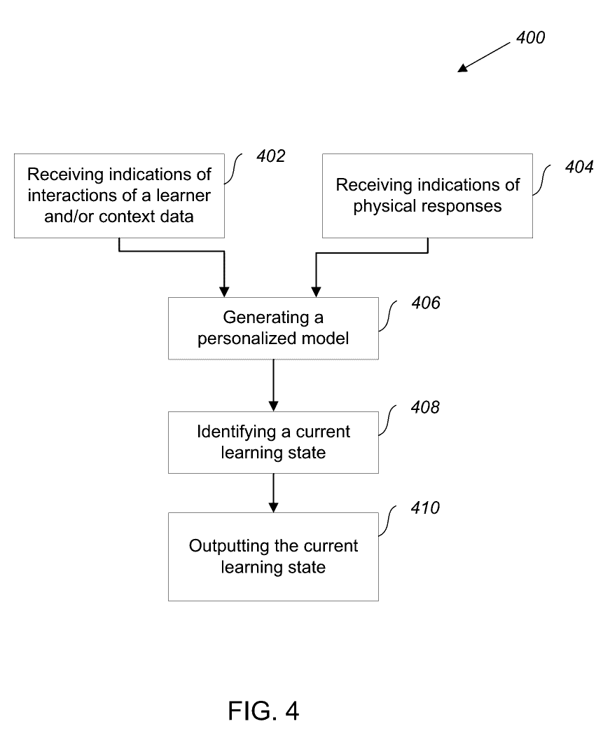

FIG. 4 is a flow diagram illustrating a method 400 for operating a learning engagement state recognition engine, including generating a personalized model, according to various embodiments. In embodiments, the method 400 may be practiced on the learning engagement state recognition engine 130 of FIG. 1. In some embodiments, prior to generating a personalized model in the method 400, the ML model 132 may be initially trained into a generic model using broad-based learner data and observed learner engagement states from a broad sample of learners. In embodiments, this data may be collected and labeled during a prior data collection phase. In these embodiments, initial identifications of learner engagement states may be based on the broad norm of the generic model and not reflect the individual learner engagement states of a particular learner. In embodiments, the generic model represented by the ML model 132 may be subsequently calibrated to one or more specific learners 102. This may enable the ML model 132 to identify a learner engagement state tailored to the specific unique culture and/or learning style of the particular learner 102, given appearance, context, and/or performance data.

At a block 402, the method 400 may include receiving indications of interactions of a learner and/or context data. The indications of interactions of the learner may include performance data from instruction module 106 used to identify performance features in various embodiments. The context data may include environmental data 122, learner data 124, and or context data from the instruction module 106 that may be used to identify contextual features. A block 404 may include receiving indications of physical responses that may be collected substantially simultaneously as the indications of interactions of the learner as the learner interacts with an educational program.

A block 406 may include generating a personalized model using a machine learning process based at least in part on the interactions of the learner and the indications of physical responses of the learner during a calibration time period. Generating the personalized model may include retraining an appearance classifier of the generic model using labels assigned by a performance classifier using the performance data and/or a context classifier using the context data of the generic model. In some embodiments, a machine learning algorithm or technique such as a random forest or a boosted SVM, or some other machine learning technique may be used to retrain the appearance classifier in a semi-supervised learning process.

A block 408 may include identifying a current learning state of the learner based at least in part on the personalized model and the indications of physical responses of the learner in a usage time period. In some embodiments, a confidence level of the current learning state may also be determined. In various embodiments, a request for a current learning state of the learner may be received during a usage time period and identifying the current learning state may be in response to receiving the request. A block 410 may include outputting the current learning state and may also include outputting the confidence level of the current learning state in some embodiments.

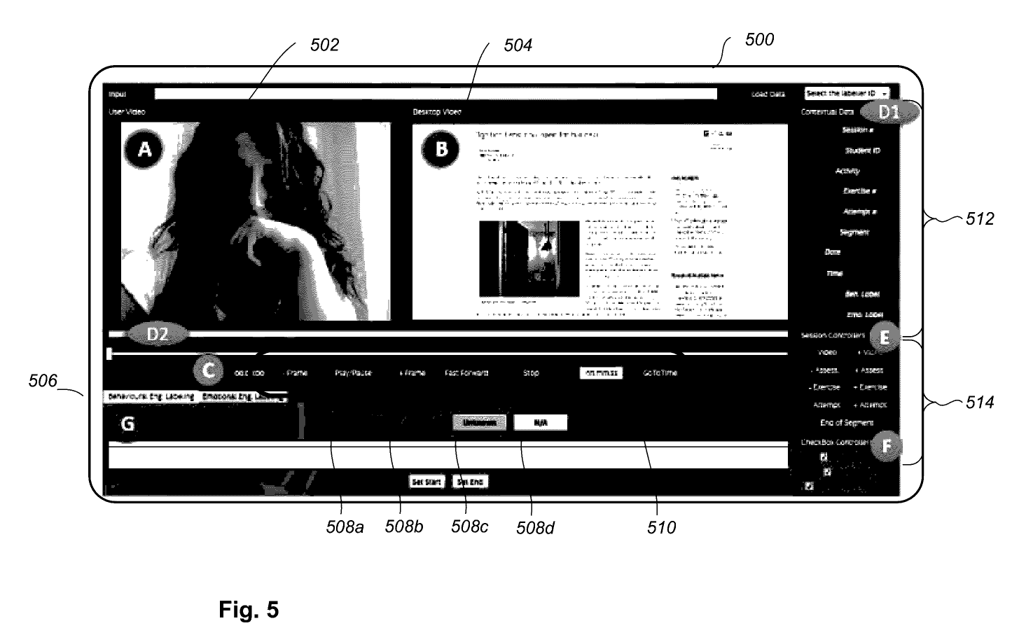

Referring now to FIG. 5, wherein a diagram illustrating an example user interface for a program that may be used by labelers to label learner engagement states, according to various embodiments that allow labeling by a human, is shown.

In embodiments, a labeling tool 500 may allow the labeler 120 to identify and label the current learning engagement state of the learner 102 who is not in proximity of the labeler. In embodiments, the labeler 120 may receive visual or auditory information from learner sensing equipment 108. In embodiments, this data may be retrieved by the Intel® RealSense™ SDK capturing utility (not shown) from the instruction module 106 or from the user interface on educational device 104. In embodiments, the head or face of learner 102 may be shown in window 502, and the educational device 104 user interface, with which the learner is interacting, may be presented in window 504. In embodiments, these two windows may be synchronized so that they may display substantially simultaneously the learner 102 and the learner's interaction with the educational device 104.

In embodiments, a labeler 120 may use pre-defined labels for identifying a particular learner 102 learning engagement state. In embodiments, a labeler 120 may select the behavioral labeling button 506, which may cause sub buttons associated with behavioral labels to appear 508a, 508b, 508c, 508d. The labeler may then select the appropriate learner 102 engagement state. Identifying an emotional state may be done in a similar fashion. In addition, in embodiments, window 502 and window 504 may present substantially simultaneous activities that may have occurred in the past and have been recorded. The labeler 120 may wish to identify and label the learner 102 learning engagement state in order to calibrate and/or update the ML model 132 for the learner. In these embodiments, buttons 510 may be used to move around in the learner/educational device time sequence recording. In other embodiments, keyboard characters, a mouse, tablet or other input device may be used to move around in the time sequence recording.

Contextual data, as referred to above, may be shown and or modified using the controls 512. In addition, Windows button controllers 514 may be used to jump to the next/previous video segment, assessment segment, exercise in the assessment segment, and attempt in the exercise, and to jump to the end of each segment. In addition, mouse location information or mouse tics may also be included in the learner engagement state analysis, in addition to where the learner 102 eyes look on the educational device 104.

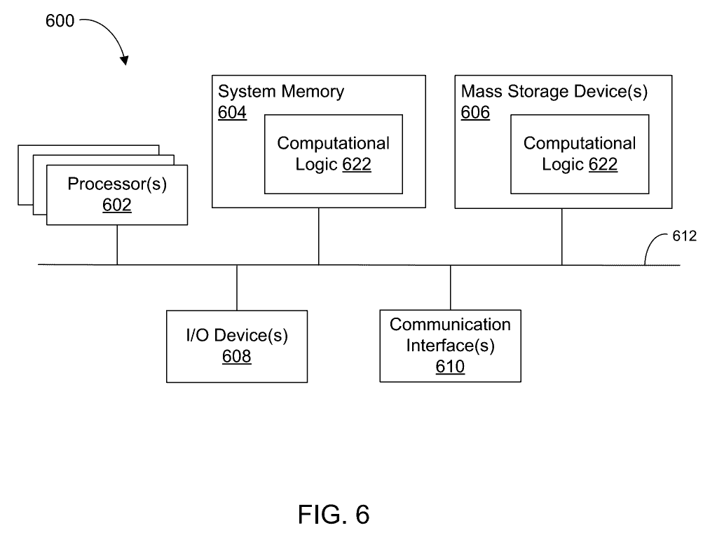

Referring now to FIG. 6, wherein an example computing device 600 suitable to implement the learning engagement state recognition engine 130, instruction module 106, report learner engagement state module 128, and/or other devices or methods described with respect to FIGS. 1-5, in accordance with various embodiments, is illustrated. As shown, computing device 600 may include one or more processors or processor cores 602, and system memory 604. In embodiments, multiple processor cores 602 may be disposed on one die. For the purpose of this application, including the claims, the terms “processor” and “processor cores” may be considered synonymous, unless the context clearly requires otherwise. Additionally, computing device 600 may include mass storage device(s) 606 (such as diskette, hard drive, compact disc read-only memory (CDROM), and so forth), input/output (I/O) device(s) 608 (such as display, keyboard, cursor control, and so forth), and communication interfaces 610 (such as network interface cards, modems, and so forth). In embodiments, a display unit may be touch screen sensitive and may include a display screen, one or more processors, storage medium, and communication elements. Further, it may be removably docked or undocked from a base platform having the keyboard. The elements may be coupled to each other via system bus 612, which may represent one or more buses. In the case of multiple buses, they may be bridged by one or more bus bridges (not shown).

Each of these elements may perform its conventional functions known in the art. In particular, system memory 604 and mass storage device(s) 606 may be employed to store a working copy and a permanent copy of programming instructions implementing the operations described earlier, e.g., but not limited to, operations associated with learning engagement state learning recognition engine 130, instruction module 106, and/or report learner engagement state module 128, generally referred to as computational logic 622. The various operations may be implemented by assembler instructions supported by processor(s) 602 or high-level languages, such as, for example, C, that may be compiled into such instructions.

The permanent copy of the programming instructions may be placed into permanent mass storage device(s) 606 in the factory, or in the field, through, for example, a distribution medium (not shown), such as a compact disc (CD), or through communication interface 610 (from a distribution server (not shown)). That is, one or more distribution media having an implementation of the learning engagement state recognition engine 130, instruction module 106, and/or report learner engagement state module 128, may be employed to distribute the learning engagement state recognition engine 130, instruction module 106, and/or report learner engagement state module 128, and program various computing devices.

The number, capability, and/or capacity of these elements 610-612 may vary, depending on the intended use of example computing device 600, e.g., whether example computer 600 is a smartphone, tablet, ultra-book, laptop, or desktop. The constitutions of these elements 610-612 are otherwise known, and accordingly will not be further described.

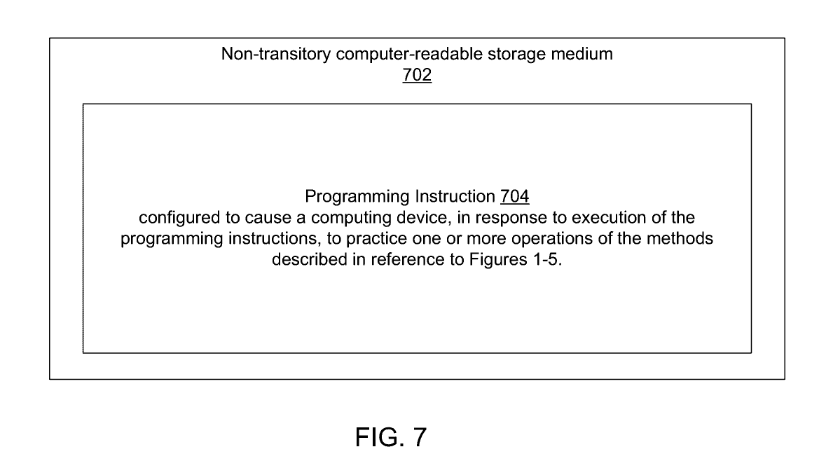

FIG. 7 illustrates an example non-transitory computer-readable storage medium having instructions configured to practice all or selected ones of the operations associated with learning engagement state recognition engine 130, instruction module 106, report learner engagement state module 128, and/or other devices or methods described with respect to FIGS. 1-5, in accordance with various embodiments. As illustrated, non-transitory computer-readable storage medium 702 may include a number of programming instructions 704. Programming instructions 704 may be configured to enable a device, e.g., computing device 600, in response to execution of the programming instructions, to perform one or more operations of the processes described in reference to FIGS. 1-5. In alternate embodiments, programming instructions 704 may be disposed on multiple non-transitory computer-readable storage media 702 instead. In still other embodiments, programming instructions 704 may be encoded in transitory computer-readable signals.

Referring back to FIG. 6, for one embodiment, at least one of processors 602 may be packaged together with computational logic 622 (in lieu of storing in memory 604 and/or mass storage 606) configured to perform one or more operations of the processes described with reference to FIGS. 1-5. For one embodiment, at least one of processors 602 may be packaged together with computational logic 622 configured to practice aspects of the methods described in reference to FIGS. 1-5 to form a System in Package (SiP). For one embodiment, at least one of processors 602 may be integrated on the same die with computational logic 622 configured to perform one or more operations of the processes described in reference to FIGS. 1-5. For one embodiment, at least one of processors 602 may be packaged together with computational logic 622 configured to perform one or more operations of the process described in reference to FIGS. 1-5 to form a System on Chip (SoC). Such an SoC may be utilized in any suitable computing device.

For the purposes of this description, a computer usable or computer-readable medium can be any apparatus that can contain, store, communicate, propagate, or transport the program for use by or in connection with an instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read-only memory (CD-ROM), compact disk-read/write (CD-R/W), and digital video disk (DVD).

### EXAMPLES

Example 1 may include an apparatus to provide a computer-aided educational program, comprising: one or more processors; a receive module, to be operated on the one or more processors, to receive indications of interactions of a learner with the educational program and to receive indications of physical responses of the learner collected substantially simultaneously as the learner interacts with the educational program; a calibration module, to be operated on the one or more processors, to generate a personalized model using a machine learning process based at least in part on the interactions of the learner and the indications of physical responses of the learner during a calibration time period; and a learning state identification module, to be operated on the one or more processors, to identify a current learning state of the learner based at least in part on the personalized model and the indications of physical responses of the learner during a usage time period, wherein the current learning state of the learner is used to tailor computerized provision of the education program during the usage time period.

Example 2 may include the subject matter of Example 1, wherein the machine learning process includes using a random forest technique.

Example 3 may include the subject matter of any one of Examples 1-2, wherein the machine learning process includes training a support vector machine.

Example 4 may include the subject matter of any one of Examples 1-3, wherein the calibration module is to generate the personalized model by retraining an appearance classifier of a generic model having the appearance classifier and one or more of a performance classifier or a context classifier.

Example 5 may include the subject matter of Example 4, wherein the generic model includes a performance classifier and a context classifier.

Example 6 may include the subject matter of Example 5, wherein the calibration module is to determine a learning state label based at least in part on one or more of the performance classifier or the context classifier, and retrain the appearance classifier based at least in part on the learning state label.

Example 7 may include the subject matter of Example 6, wherein the learning state identification module is to identify the current learning state based at least in part on the retrained appearance classifier.

Example 8 may include the subject matter of any one of Examples 5-7, wherein the receive module is also to receive indications of learning context, and the calibration module is to determine a learning state label based at least in part on the indications of learning context and the context classifier, and wherein the calibration module is to retrain the appearance classifier based at least in part on the learning state label.

Example 9 may include the subject matter of any one of Examples 1-8, wherein the indications of physical responses of the learner during the calibration period include at least one of an image or video of the learner and the indications of physical responses of the learner during the usage time period include at least one of an image or video of the learner.

Example 10 may include the subject matter of any one of Examples 1-9, wherein the current learning state of the learner is at least one of a behavioral state or an emotional state.

Example 11 may include an apparatus to implement a personalized machine learning model comprising: one or more processors; a receive module, to be operated on the one or more processors, to: receive indications of interactions of a learner with an educational program; receive indications of physical responses of the learner collected substantially simultaneously as the learner interacts with the educational program; and receive a request for a current learning state of the learner during a usage time period; a machine learning model training module, to be operated on the one or more processors, to generate the personalized machine learning model based upon the received indications of interactions and the received indications of physical responses during a calibration time period; an output module, to be operated on the one or more processors, to: in response to the received request, determine a current learning state from the personalized machine learning model and the indications of physical responses during the usage time period; and output the determined current learning state.

Example 12 may include the subject matter of Example 11, wherein the machine learning model training module is to generate the personalized machine learning model using a random forest technique.

Example 13 may include the subject matter of Example 11, wherein the machine learning model training module is to generate the personalized machine learning model using a support vector machine.

Example 14 may include the subject matter of any one of Examples 11-13, wherein the machine learning model training module is to generate the personalized machine learning model by retraining an appearance classifier of a generic machine learning model having the appearance classifier and a performance classifier.

Example 15 may include the subject matter of Example 14, wherein the generic machine learning model also includes a context classifier.

Example 16 may include the subject matter of Example 15, wherein the personalized machine learning model is a merged model including the retrained appearance classifier, the performance classifier, and the context classifier.

Example 17 may include the subject matter of any one of Examples 11-16, wherein the output module is further to determine a confidence level for the determined learning state using the personalized machine learning model and output the confidence level.

Example 18 may include a method for computerized assisted learning, comprising: receiving, by a learning state engine operating on a computing system, indications of interactions of a learner with a computerized educational program presented through an educational device; receiving, by the learning state engine, indications of physical responses of the learner collected substantially simultaneously as the learner is interacting with the educational program; generating, by the learning state engine, a personalized model using a machine learning process by retraining an appearance classifier of a generic model based at least in part on the indications of interactions and the indications of physical responses during a calibration time period; identifying, by the learning state engine, a current learning state of the learner, based at least in part on the personalized model and the indications of physical responses during a usage time period; and outputting, by the learning state engine, the current learning state of the learner, wherein the current learning state of the learner is used to tailor computerized provision of the education program.

Example 19 may include the subject matter of Example 18, wherein generating the personalized model includes generating the personalized model using at least one of a random forest technique or a support vector machine.

Example 20 may include the subject matter of any one of Examples 18-19, wherein generating the personalized model includes: generating a learning state label using at least one of a context or a performance classifier of the generic model in response to a confidence level of an initial label assigned by an appearance classifier is below a predefined threshold value; and retraining the appearance classifier based at least in part on the learning state label.

Example 21 may include one or more computer-readable media comprising instructions that cause a computing device, in response to execution of the instructions by the computing device, to: receive indications of interactions of a learner with a computerized educational program presented through an educational device; receive indications of physical responses of the learner collected substantially simultaneously as the learner is interacting with the educational program; generate a personalized model using a machine learning process by retraining an appearance classifier of a generic model based at least in part on the indications of interactions and the indications of physical responses during a calibration time period; identify a current learning state of the learner, based at least in part on the indications of physical responses and the personalized model during a usage time period; and output the current learning state of the learner, wherein the current learning state of the learner is used to tailor computerized provision of the education program.

Example 22 may include the subject matter of Example 21, wherein the computing device is further caused to generate a learning state label using at least one of a context classifier or a performance classifier of the generic model during the calibration time period; and generate the personalized model based at least in part on the learning state label.

Example 23 may include the subject matter of Example 22, wherein the computing device is caused to generate the learning state label using at least one of the context classifier or the performance classifier of the generic model in response to a confidence level of an initial label assigned by the appearance classifier is below a predefined threshold value.

Example 24 may include the subject matter of any one of Examples 21-23, wherein the computing device is caused to generate the personalized model using at least one of a random forest technique or a support vector machine.

Example 25 may include the subject matter of any one of Examples 21-24, wherein the computing device is further caused to receive indications of learning context and generate the personalized model based at least in part on the indications of learning context received during the calibration period.

Example 26 may include an apparatus to provide computerized assisted learning comprising: means for receiving indications of interactions of a learner with a computerized educational program presented through an educational device; means for receiving indications of physical responses of the learner collected substantially simultaneously as the learner is interacting with the educational program; means for generating a personalized model using a machine learning process by retraining an appearance classifier of a generic model based at least in part on the indications of interactions and the indications of physical responses during a calibration time period; means for identifying a current learning state of the learner, based at least in part on the personalized model and the indications of physical responses during a usage time period; and means for outputting the current learning state of the learner, wherein the current learning state of the learner is used to tailor computerized provision of the education program.

Example 27 may include the subject matter of Example 26, wherein the means for generating the personalized model includes means for generating the personalized model using at least one of a random forest technique or a support vector machine.

Example 28 may include the subject matter of any one of Examples 26-27, wherein generating the personalized model includes: means for generating a learning state label using at least one of a context or a performance classifier of the generic model in response to a confidence level of an initial label assigned by an appearance classifier is below a predefined threshold value; and means for retraining the appearance classifier based at least in part on the learning state label.

Example 29 may include an apparatus to provide a computer-aided educational program, comprising: one or more processors; a receive module, to be operated on the one or more processors, to receive indications of interactions of a learner with the educational program and to receive indications of physical responses of the learner collected substantially simultaneously as the learner interacts with the educational program, wherein the indications of physical responses of the learner include one or more of indications of learner facial expression, indications of learner eye tracking, indications of learner speech, indications of learner gesture, or indications of learner posture; a calibration module, to be operated on the one or more processors, to generate a personalized model using a machine learning process based at least in part on the interactions of the learner and the indications of physical responses of the learner during a calibration time period; and a learning state identification module, to be operated on the one or more processors, to identify a current learning state of the learner based at least in part on the personalized model and the indications of physical responses of the learner during a usage time period, wherein the current learning state of the learner is used to tailor computerized provision of the education program during the usage time period.

Example 30 may include the subject matter of Example 29, wherein the indications of physical responses of the learner include two or more of indications of learner facial expression, indications of learner eye tracking, indications of learner speech, indications of learner gesture, or indications of learner posture.

Example 31 may include the subject matter of any one of Examples 2-10, wherein the indications of physical responses of the learner include one or more of indications of learner facial expression, indications of learner eye tracking, indications of learner speech, indications of learner gesture, or indications of learner posture.

Example 32 may include the subject matter of any one of Examples 11-17, wherein the indications of physical responses of the learner include one or more of indications of learner facial expression, indications of learner eye tracking, indications of learner speech, indications of learner gesture, or indications of learner posture.

Example 33 may include the subject matter of any one of Examples 18-20, wherein the indications of physical responses of the learner include one or more of indications of learner facial expression, indications of learner eye tracking, indications of learner speech, indications of learner gesture, or indications of learner posture.

Example 34 may include the subject matter of any one of Examples 21-25, wherein the indications of physical responses of the learner include one or more of indications of learner facial expression, indications of learner eye tracking, indications of learner speech, indications of learner gesture, or indications of learner posture.

Example 35 may include the subject matter of any one of Examples 26-28, wherein the indications of physical responses of the learner include one or more of indications of learner facial expression, indications of learner eye tracking, indications of learner speech, indications of learner gesture, or indications of learner posture.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

What is claimed is:

1. An apparatus to provide a computer-aided educational program, comprising:
one or more processors;
a receive module, to be operated on the one or more processors, to receive indications of interactions of a learner with the educational program and to receive indications of physical responses of the learner collected substantially simultaneously as the learner interacts with the educational program;
a calibration module, to be operated on the one or more processors, to generate a personalized model using a machine learning process based at least in part on the interactions of the learner and the indications of physical responses of the learner during a calibration time period; and
a learning state identification module, to be operated on the one or more processors, to identify a current learning state of the learner based at least in part on the personalized model and the indications of physical responses of the learner during a usage time period,
wherein the current learning state of the learner is used to tailor computerized provision of the education program during the usage time period.

2. The apparatus of claim 1, wherein the machine learning process includes using a random forest technique.

3. The apparatus of claim 1, wherein the machine learning process includes training a support vector machine.

4. The apparatus of claim 1, wherein the calibration module is to generate the personalized model by retraining an appearance classifier of a generic model having the appearance classifier and one or more of a performance classifier or a context classifier.

5. The apparatus of claim 4, wherein the generic model includes a performance classifier and a context classifier.

6. The apparatus of claim 5, wherein the calibration module is to determine a learning state label based at least in part on one or more of the performance classifier or the context classifier, and retrain the appearance classifier based at least in part on the learning state label.

7. The apparatus of claim 6, wherein the learning state identification module is to identify the current learning state based at least in part on the retrained appearance classifier.

8. The apparatus of claim 5, wherein the receive module is also to receive indications of learning context, and the calibration module is to determine a learning state label based at least in part on the indications of learning context and the context classifier, and wherein the calibration module is to retrain the appearance classifier based at least in part on the learning state label.

9. The apparatus of claim 1, wherein the indications of physical responses of the learner during the calibration period include at least one of an image or video of the learner and the indications of physical responses of the learner during the usage time period include at least one of an image or video of the learner.

10. The apparatus of claim 1, wherein the current learning state of the learner is at least one of a behavioral state or an emotional state.

11. An apparatus to implement a personalized machine learning model comprising:
one or more processors;
a receive module, to be operated on the one or more processors, to:
receive indications of interactions of a learner with an educational program;
receive indications of physical responses of the learner collected substantially simultaneously as the learner interacts with the educational program; and
receive a request for a current learning state of the learner during a usage time period;
a machine learning model training module, to be operated on the one or more processors, to generate the personalized machine learning model based upon the received indications of interactions and the received indications of physical responses during a calibration time period;
an output module, to be operated on the one or more processors, to:
in response to the received request, determine a current learning state from the personalized machine learning model and the indications of physical responses during the usage time period; and
output the determined current learning state.

12. The apparatus of claim 11, wherein the machine learning model training module is to generate the personalized machine learning model using a random forest technique.

13. The apparatus of claim 11, wherein the machine learning model training module is to generate the personalized machine learning model using a support vector machine.

14. The apparatus of claim 11, wherein the machine learning model training module is to generate the personalized machine learning model by retraining an appearance classifier of a generic machine learning model having the appearance classifier and a performance classifier.

15. The apparatus of claim 14, wherein the generic machine learning model also includes a context classifier.

16. The apparatus of claim 15, wherein the personalized machine learning model is a merged model including the retrained appearance classifier, the performance classifier, and the context classifier.

17. The apparatus of claim 11, wherein the output module is further to determine a confidence level for the determined learning state using the personalized machine learning model and output the confidence level.

18. A method for computerized assisted learning, comprising:
receiving, by a learning state engine operating on a computing system, indications of interactions of a learner with a computerized educational program presented through an educational device;
receiving, by the learning state engine, indications of physical responses of the learner collected substantially simultaneously as the learner is interacting with the educational program;
generating, by the learning state engine, a personalized model using a machine learning process by retraining an appearance classifier of a generic model based at least in part on the indications of interactions and the indications of physical responses during a calibration time period;
identifying, by the learning state engine, a current learning state of the learner, based at least in part on the personalized model and the indications of physical responses during a usage time period; and
outputting, by the learning state engine, the current learning state of the learner, wherein the current learning state of the learner is used to tailor computerized provision of the education program.

19. The method of claim 18, wherein generating the personalized model includes generating the personalized model using at least one of a random forest technique or a support vector machine.

20. The method of claim 18, wherein generating the personalized model includes:
generating a learning state label using at least one of a context or a performance classifier of the generic model in response to a confidence level of an initial label assigned by an appearance classifier is below a predefined threshold value; and
retraining the appearance classifier based at least in part on the learning state label.

21. One or more computer-readable media comprising instructions that cause a computing device, in response to execution of the instructions by the computing device, to:
receive indications of interactions of a learner with a computerized educational program presented through an educational device;
receive indications of physical responses of the learner collected substantially simultaneously as the learner is interacting with the educational program;
generate a personalized model using a machine learning process by retraining an appearance classifier of a generic model based at least in part on the indications of interactions and the indications of physical responses during a calibration time period;
identify a current learning state of the learner, based at least in part on the indications of physical responses and the personalized model during a usage time period; and
output the current learning state of the learner, wherein the current learning state of the learner is used to tailor computerized provision of the education program.

22. The computer-readable media of claim 21, wherein the computing device is further caused to generate a learning state label using at least one of a context classifier or a performance classifier of the generic model during the calibration time period; and generate the personalized model based at least in part on the learning state label.

23. The computer-readable media of claim 22, wherein the computing device is caused to generate the learning state label using at least one of the context classifier or the performance classifier of the generic model in response to a confidence level of an initial label assigned by the appearance classifier is below a predefined threshold value.

24. The computer-readable media of claim 21, wherein the computing device is caused to generate the personalized model using at least one of a random forest technique or a support vector machine.

25. The computer-readable media of claim 21, wherein the computing device is further caused to receive indications of learning context and generate the personalized model based at least in part on the indications of learning context received during the calibration period.
